(19) United States
(12) Patent Application Publication
(10) Pub. No.: US 2005/0097600 A1
(43) Pub. Date: May 5, 2005

(54) On-demand content promotion over broadcast content

(76) Inventor: David de Heer, Woodside, CA (US)

Correspondence Address: LEE & HAYES PLLC, 421 W RIVERSIDE AVENUE SUITE 500, SPOKANE, WA, 99201, US

(21) Appl. No.: 10/700,642

(22) Filed: Nov. 3, 2003

(51) Int. Cl. H04N 7/173; G06F 13/00; H04N 5/445; H04N 7/16

(52) U.S. Cl. 725/37; 725/116; 725/146; 725/100; 725/131

(57) ABSTRACT

Systems and methods are described that facilitate the rendering on a video display device of a user interface (UI) including information promoting on-demand content and mechanisms by which a viewer of the video display device may select the on-demand content for access.

### BACKGROUND

Broadcast networks, cable networks, and other video content providers typically produce both regularly scheduled programming (broadcast content) and user selectable non-regularly scheduled programming (on-demand content), such as Video-on-Demand (VOD) programs, games, etc. In many cases, on-demand content may have some relevance to, or association with, broadcast content. For example, a VOD movie or a game may be associated with a regularly scheduled program. In such cases, it is beneficial for the video content provider to inform broadcast content viewers of the available related on-demand content.

Typically, the mechanisms available to a video content provider to inform broadcast content viewers of related on-demand content has been limited to static advertising, such as broadcast commercials and/or targeted or mass mailings. Since individual viewers may be viewing the broadcast content via systems having different on-demand content access mechanisms, or no on-demand content access mechanism at all, such static advertising has typically included only generic descriptions for receiving such content. For example, the video content provider may air commercials or send out mailings advertising on-demand content. This advertising typically instructs viewers to contact their local cable provider to determine if the advertised on-demand content is available to them. The viewer may further be advised to obtain instructions for accessing the on-demand content from their local cable provider.

Unfortunately, for various reasons, viewers are often reluctant to make such calls. As such, these types of static advertising have traditionally had a very low response rate.

### SUMMARY

Implementations described and claimed herein address the foregoing problems by providing systems and methods that facilitate the rendering on a video display device of a user interface (UI) including information promoting on-demand content. In accordance with various implementations, UI is rendered on the video display device in conjunction with broadcast content. In accordance with various implementations, the rendered UI includes various mechanisms by which a viewer of the video display device may select the on-demand content for immediately or future access.

### BRIEF DESCRIPTION OF THE DRAWINGS

FIG. 1 illustrates an exemplary an exemplary digital video broadcast system in which the systems and methods described herein may be implemented.

FIG. 2 illustrates details of selective exemplary components of the digital video broadcast system shown in FIG. 1.

FIG. 3 illustrates exemplary operations that may be carried out in or by a content provider system of the digital video broadcast system shown in FIG. 1.

FIG. 4 illustrates exemplary operations that may be carried out in or by a UI object processing system of the digital video broadcast system shown in FIG. 1.

FIG. 5 illustrates further details of selective exemplary components of the digital video broadcast system shown in FIG. 1.

FIG. 6 illustrates exemplary operations that may be carried out in or by a content distribution system of the digital video broadcast system shown in FIG. 1.

FIG. 7 illustrates an exemplary graphical user interface (GUI) that may be presented in accordance with various implementations described herein.

FIG. 8 illustrates an exemplary computing environment, which can be used to implement various systems and methods described herein.

### DETAILED DESCRIPTION

Various systems and methods are described for the presentation of audio/video content to multiple viewers in an audio/video broadcast system, such as a cable television broadcast system. In accordance with various implementations described herein, content providers, such as broadcast networks, cable networks, and the like, transmit traditional broadcast content and viewer requested on-demand content, to a content distribution system for broadcast to a number of viewer audio/video display systems.

In accordance with various implementations described herein, in addition to the traditional broadcast content and on-demand content, a viewer also receives a user interface (UI) object that is used by a UI application on the viewer's audio/video display systems to produce an interactive UI. In accordance with various implementations, the interactive UI provides information concerning currently available on-demand content. Additionally, the interactive UI provides a mechanisms by which the viewer may select the currently available on-demand content for immediately or future access. For example, the interactive UI may display a pop-up window that is superimposed over currently displayed broadcast content. The pop-up window may include a message promoting currently available on-demand content related to the currently displayed broadcast content. Additionally, the pop-up window may include mechanisms (e.g., buttons or the like) by which the viewer can either immediately access the available on-demand content or place it in list for future access.

In accordance with various implementations, UI objects are authored by content providers using a UI object authoring environment. The UI object authoring environment includes various tools though which the content providers may define the visual layout of the interactive UI that will be produced by a UI application using the UI object. The UI object authoring environment may also include various tools for defining logical operations associated with the interactive UI, such as operations that take place when a particular button or other control is manipulated by a viewer.

In accordance with one implementation, the UI object authoring environment is presented to the content providers via a UI object processing system. The UI object processing system may perform various operations with respect to the UI objects. For example, the UI object processing system may verify the UI objects and schedule them for delivery to the content distribution system. Additionally, the UI object processing system may specify the time at which the UI objects are sent from the content distribution system to the user audio/video display systems.

The UI objects are sent from UI object processing system to a content distribution system. From the content distribution system, the UI objects are selectively transmitted to appropriate audio/video display systems, where they are used by a UI interface program to produce an interactive UI. The interactive UI is then displayed on the display screen of the audio/video display system in conjunction with broadcast content.

In accordance with various implementations, the timing of the presentation of an interactive UI on an audio/video display system may be specified or requested by a content provider. For example, a content provider may specify or request from the UI object processing system that a particular interactive UI be displayed in conjunction with specified broadcast content. Then, either in conjunction with or following the delivery of the appropriate UI object to the content distribution system, the UI object processing system sends instructions to the content distribution system indicating the time and channel over which the particular interactive UI is to be displayed.

As used herein, on-demand content may be any audio/video content that is specified for transmission from a content provider to individual audio/video display systems in response to requests from, and at times specified by, the viewers of the of audio/video display systems. Some examples of on-demand content include, without limitation, Video-On-Demand (VOD) movies or other events, games that are executable on the audio/video display systems, and/or any other content that may be individually ordered and delivered to a single audio/video display system at a time specified by the viewer of an audio/video display system.

As used herein, broadcast content may be any audio/video content that is specified for simultaneous broadcast to a number of audio/video display systems. Some examples of broadcast content include, without limitation, traditional network television programming, regularly scheduled pay-per-view movies, subscriber information programming, or any other type of audio/video programming that is intended for simultaneously broadcast from a content provider to a number of audio/video display systems.

In general, a UI object is a data object including data and/or logic for use by a UI application running on an audio/video display system in rendering an interactive UI. In accordance with one implementation, each UI object, and the interactive UI that is created therefrom, is related to the broadcast content over which the interactive UI is rendered. For example, an interactive UI may notify a viewer of available on-demand content that is related in some way to the broadcast content over which the interactive UI is rendered. In addition to a notification, the interactive UI may present various options for accessing the related on-demand content. Furthermore, the interactive UI may present an “onscreen” mechanism by which the various options presented may be selected.

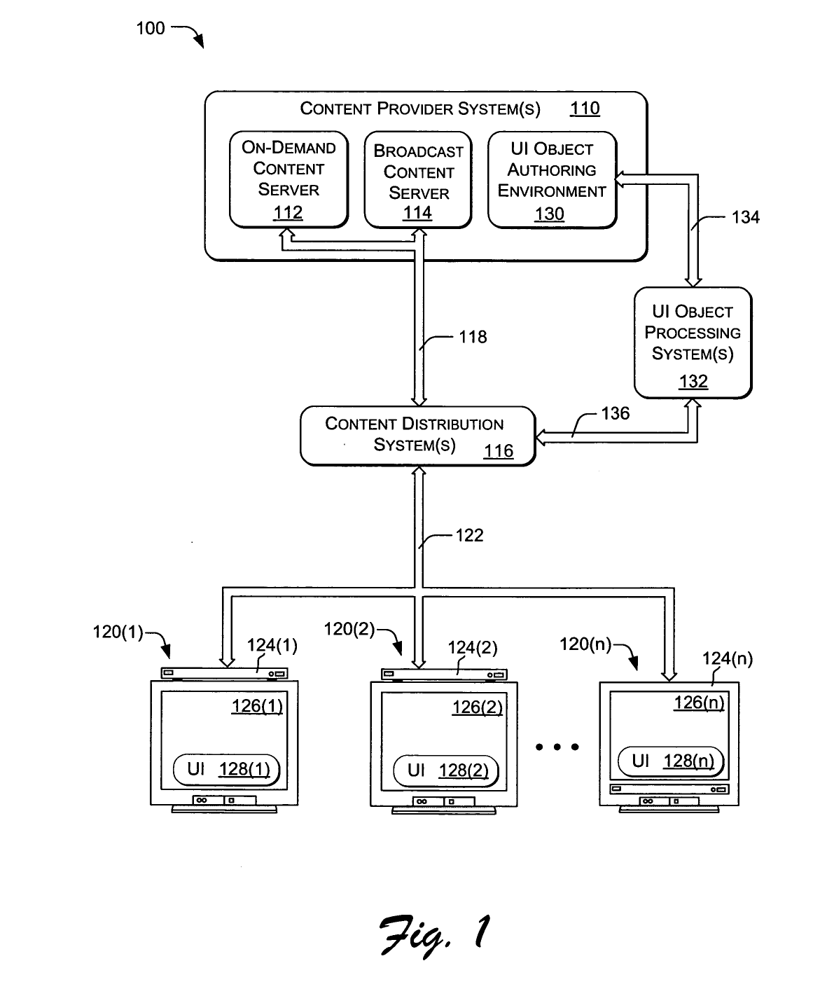

Turning to the drawings, wherein like reference numerals refer to like elements, FIG. 1 illustrates an exemplary video broadcast system 100. Included in the exemplary audio/video broadcast system 100 are a content provider system 110, a content distribution system 116, a UI object processing system, and a number of audio/video display systems 120(1), 120(2), . . . , 120(n).

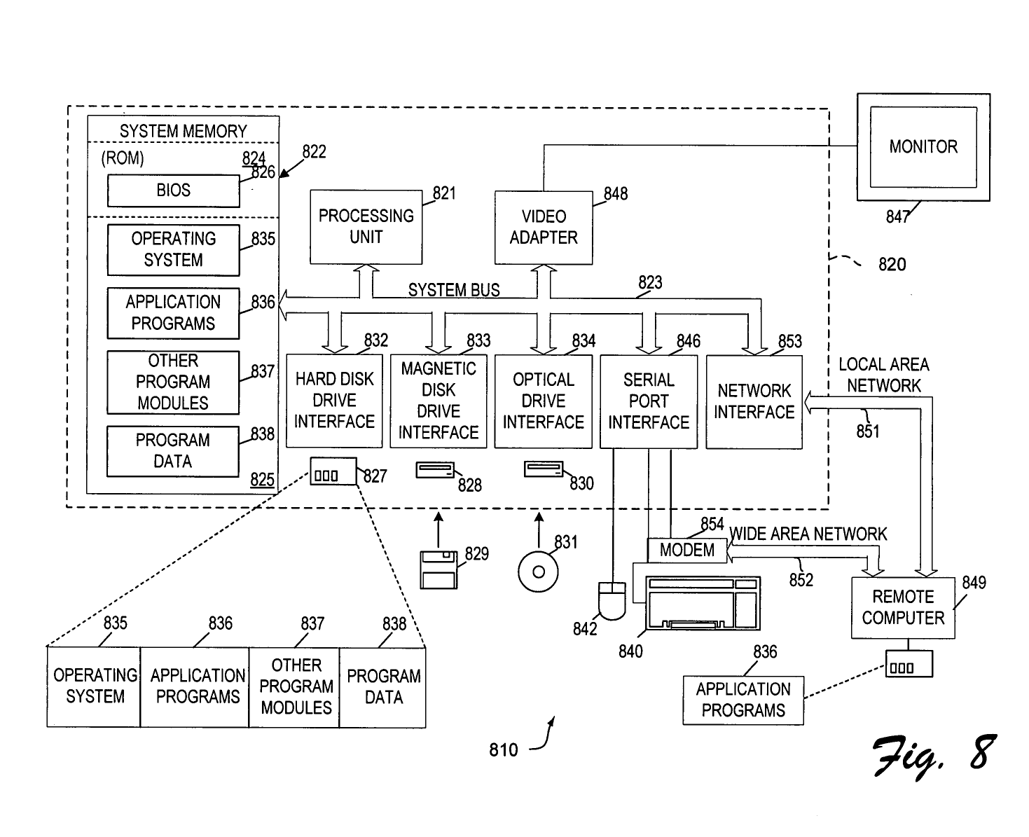

In general, the content provider system 110 provides functionality related to the creation, storage, management and/or distribution of on-demand content 112 and broadcast content 114 to the content distribution system 116. Included in the content provider system 110 are an on-demand content server 112, a broadcast content server 114, and a UI object authoring environment 130. In accordance with one implementation, the content provider system 110 includes or is embodied in a computing system, such as described below with respect to FIG. 8.

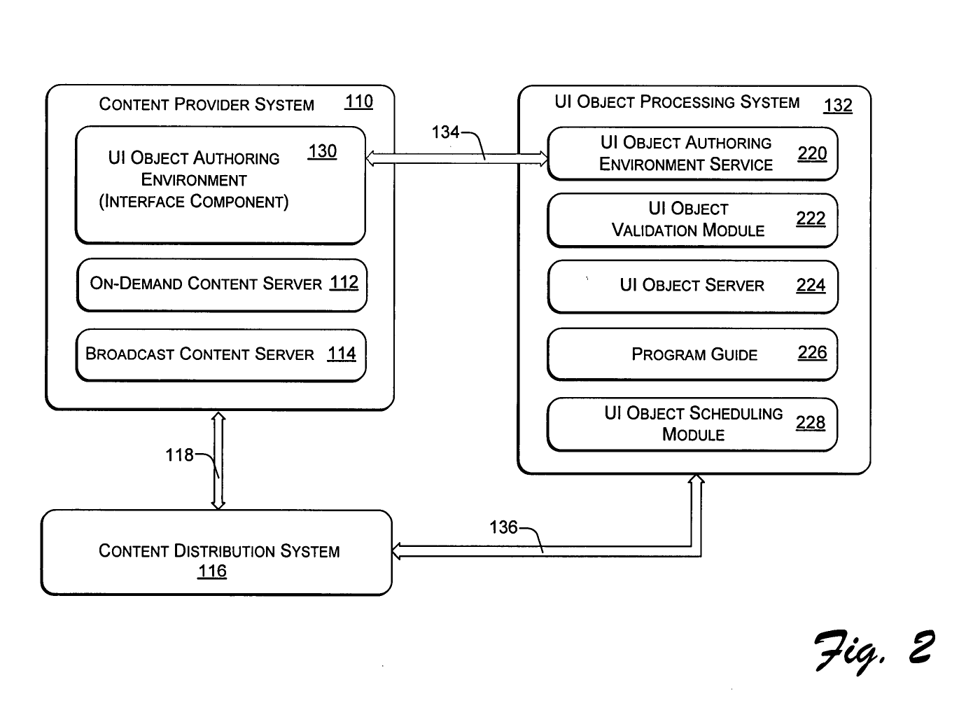

The on-demand content server 112 performs various functions related to the storage and management of on-demand content, and well as functions related to delivery of on-demand content to the content distribution system 116. Similarly, the broadcast content server 114 performs various functions related to the storage and management of broadcast content, and the delivery of broadcast content to the content distribution system 116. The UI object authoring environment 132 provides a user interactive environment for the authoring of UI objects. Further details regarding the structure and function of the on-demand content server 112, the broadcast content server 114, and the UI object authoring environment 132 are provided below with respect to FIG. 2.

The content provider system 110 is operably connected to the content distribution 116 center via a content transmission channel 118. Likewise, the content provider system 110 is operable connected to the UI object processing system 132 via a UI object communication channel 134. Either the content transmission channel 118 or the UI object communication channel 134 may comprise any type and/or number of communication channels suitable for transmitting digital data. For example, and without limitation, in accordance with one implementation, the content transmission channel 118 is a satellite up-link transmission facility. In accordance with one implementation, and without limitation, the UI object communication channel 134 is an IP-oriented data transmission system using a Virtual Private Network over the public Internet for data carriage.

In general, the UI object processing system 132 provides functionality related to the creation of UI objects. For example, in accordance with one implementation, the UI object processing system 132 provides the UI object authoring environment to the content provider system 110 via a web service. Additionally, the UI object processing system 132 provides various functionality regarding the management, storage, and/or delivery of UI objects. For example, as described below with respect to FIG. 2, the UI object processing system 132 may provide functionality related to the verification of UI objects and the delivery of UI objects and UI applications to the content distribution systems 116. In accordance with one implementation, the UI object processing system 132 includes or is embodied in a computing system, such as described below with respect FIG. 8. Further details regarding the structure and function of the UI object processing system 132 are provided below with respect to FIG. 2.

The UI object processing system 132 is operably connected to the content distribution 116 center via a UI object transmission channel 136. In general, the UI object transmission channel 136 may comprise any type and/or number of communication channels that are suitable for transmitting digital data. For example, and without limitation, in accordance with one implementation, the UI object transmission channel 136 is an IP-oriented data transmission system using a Virtual Private Network over the public Internet for data carriage.

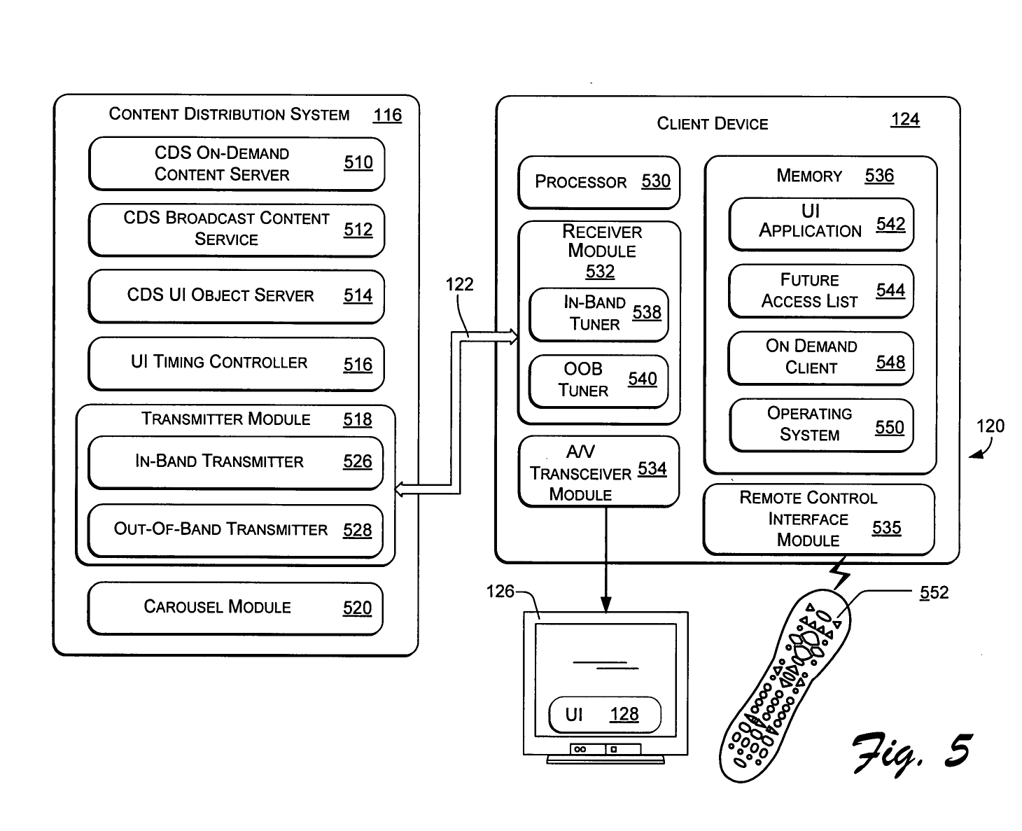

In general, the content distribution system 116 provides functionality related to the broadcasting of on-demand content, broadcast content, UI objects, and UI applications to the audio/video display systems 120. In accordance with one implementation, and without limitation, the content distribution system 116 comprises a cable television system headend. In accordance with one implementation, the content distribution system 116 includes or is embodied in a computing system, such as described below with respect to FIG. 8. Further details regarding the structure and function of the content distribution system 116 are described below with respect to FIG. 5.

The content distribution system 116 transmits the on-demand content, broadcast content, UI objects, and UI applications to the audio/video display systems 120 via a content distribution channel 122. In general, the content distribution channel 122 may comprise any type and number of communication channels that are suitable for transmitting digital data. For example, and without limitation, in accordance with one implementation, the content distribution channel 122 is a multiplexed Hybrid Fiber-Coaxial digital television transmission channel.

Each audio/video display system 120 includes a client device 124 operably connected to or integrated with a video display 126. As described in greater detail below, each client device 124 may include a UI application that renders an interactive UI 128 on the audio/video display device connected thereto or integrated therewith. In accordance with one implementation, and without limitation, a client device 124 may comprise a “set-top-box” and a video display 126 may comprise a television.

Although FIG. 1 shows a single content provider system 110 operably connection to a single content distribution system 116, the audio/video broadcast system 100 may include any number of content provider systems 110, each of which is operably connected to any number of content distribution systems 116. Furthermore, any number of content provider systems 110 may operable connected to the UI object processing system 132. Likewise, the UI object processing system 132 may be operably connected to any number of content distribution systems 116. In this way, a single UI object processing system 132 may process UI objects from a number of content provider systems 110, and deliver UI objects to a number of content distribution systems 116.

Having generally described the exemplary audio/video broadcast system 100, a more detailed description of the structure and functions of the constituent parts of the audio/video broadcast system 100 will now be provided. FIG. 2 illustrates further details of the exemplary content provider system 110 and UI object processing system 132 described with respect to FIG. 1. As previously described, the content provider system includes an UI object authoring environment 130, an on-demand content server 112, and a broadcast content server 114.

In accordance with one implementation, the UI object authoring environment 130 comprises computer executable code that presents various tools and templates for the creation of UI objects. The UI object authoring environment 130 may either be graphical or text based. The UI object authoring environment 130 may reside entirely at the content provider system 110. For example the authoring environment may comprise a computer executable application program or a suite of computer executable application programs that resides at the content provider system 110. Alternatively, the UI object authoring environment 130 may reside primarily at the UI object processing system 132, with an interface component and residing at the content provider system 110.

For example, in accordance with one embodiment, the UI object authoring environment comprises a web or application service having an authoring environment interface component 130 at the content provider system 110 and a corresponding authoring environment web service 220 at the UI object processing system 132. In such a case, the UI object authoring environment interface component 130 and the corresponding UI object authoring environment web service 220 may share business logic, data, and processes tasks through a programmatic interface across a network, such as network 134.

In accordance with one implementation, the UI object authoring environment includes a graphical user interface (GUI) in which the directions for creating various visual elements and logical operations of an interactive UI may be specified and compiled into a UI object. For example, the authoring environment 130 may include tools and templates for selecting, associating, and viewing GUI items such as windows, text, buttons, colors, etc. Additionally, the authoring environment 130 may include tools for defining functional operations associated with the features of an overlay UI and/or of an UI application.

In general, a UI object may comprise any type of data arranged in any manner that can be used by a UI application at a client device 124 to render an UI on a video display 126. For example, and without limitation, in accordance with one implementation, the UI object includes data specifying the arrangement, size, color, and other characteristics of various windows, text fields, controls, buttons, and other user interface features that are to be rendered on a video display. In accordance with one implementation, each UI object comprises a binary resource file. In accordance with other implementations, a UI object may comprise other types of files or formats that may be used by a UI application for rendering a UI on a on a video display 126.

In addition to authoring UI objects, each content provider system 110 may also provide UI object scheduling information to the UI object processing system 132, which specifies when the UI objects are to be used to render interactive UIs on one or more of the audio/video display systems 120. The UI object scheduling information may specify, without limitation, such things as the broadcast content to which a given UI object is associated, one or more content distribution systems over which the associated broadcast content is to be broadcast, and/or a specific time or times within the broadcast of the associated broadcast content at which an interactive UI is to be rendered using the UI object. Those skilled in the art will appreciate that the scheduling information may include various other information that may be useful in specifying when a UI object is to be used to render an interactive UI.

In accordance with one implementation, the UI object scheduling information is created as a part of the UI objects to which it is relevant. In accordance with another implementation, the UI object scheduling information is created separately from the UI objects to which it is relevant. In such a case, the UI object scheduling information may include information identifying the UI objects to which it is relevant.

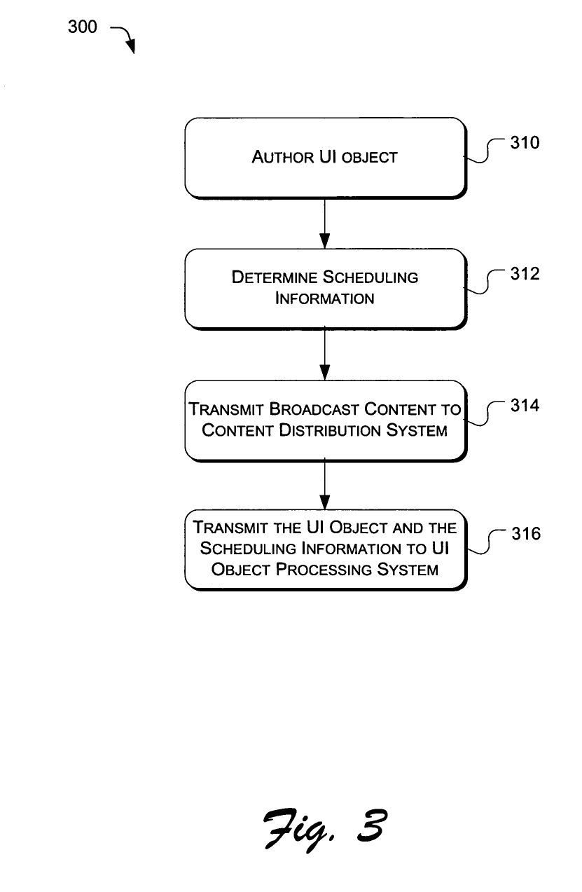

FIG. 3 illustrates an operational flow 300 or algorithm including various operations or algorithmic steps that may be performed at or by the content provider system 110. As shown, at the beginning of the operational flow 300, a UI object is authored at authoring operation 310. As previously described, UI objects are authored at the content provider system 110 using a UI object authoring environment.

In accordance with one implementation, the UI object authored in operation 310 includes directions for rendering a UI including information related to specific on-demand content on an audio/video display system. In accordance with one implementation, the authored UI object includes directions for rendering a UI including information promoting the specific on-demand content. In particular, the authored UI object may include directions for rendering a UI including information promoting specific on-demand content that is transmitted from the content provider system 110 to one or more content distribution systems 116, for eventual transmission to audio/video display devices 120.

In addition to the information related to specific on-demand content on an audio/video display system, the UI object authored at operation 310 may include directions for rendering a UI selection mechanism, such as a button or the like, which allows a user of an audio/video display device 120 to select the specific on-demand content for immediate or future viewing or access by the audio/video display device 120.

Next, scheduling information for the UI object is determined at scheduling determination operation 312. In accordance with one implementation, the scheduling information includes information that may be used by the scheduling module 228 of the UI object processing system 132, as described in greater detail below.

Next, a transmit operation 314 transmits broadcast content to the content distribution system 116. In accordance with one implementation, the broadcast content that is transmitted to the content distribution system 116 is related in some way to the UI object authored in operation 310. For example, and without limitation, the UI object may contain information rendering a UI advertising specific on-demand content that is in some way related to the broadcast content.

Next, a transmit operation 316 transmits the UI object authored at operation 310 and the scheduling information determined at step 312 to the UI object processing system 132. The UI object and the scheduling information may be transmitted simultaneously or at different times.

It should be appreciated that while the operations of the operational flow 300 are shown in a particular order in FIG. 3, these operations 300 are not necessarily limited to the order shown. Rather, the order of the operation 300 may be varied to meet the particular requirements of the content provider system 110, the UI object processing system 132, and/or the requirements of the content distribution system 116.

Turning next to the UI object processing system 132, in general the UI object processing system 132 provides functionality related authoring, validation, storage, transmission, and scheduling of UI objects. In addition to the UI authoring environment service 220 previously described, the UI object processing system 132 further includes a UI object validation module 222, a UI object server 224, a program guide 226, and a UI object scheduling module 228.

In general the UI object validation module 222 provides various functionality with respect to the verification of UI objects authored using the UI object authoring environment. For example, in accordance with one implementation, the UI object validation module 222 includes a UI object rule set including a number of UI object rules which specify various valid and/or invalid parameters for UI objects. Included in these rules are syntax checking, including validation of length, format, parameters, and correctness. In this implementation, as a UI object is created, or otherwise made available to the validation module 222, the UI object is checked against the UI rule set to determine the validity of the UI object.

Once validated, UI objects are stored by the UI object server 224. The UI object server 224 provides functionality related to the storage and transmission of UI objects to content distribution systems 116 operable connected thereto. In accordance with one implementation, the UI object server 224 includes or has access to computer-readable medium on which it stores received UI objects. Additionally, in the case where UI object scheduling information is not created as a part of its associated UI object, the UI object store 224 may also store the UI object scheduling information.

In addition to storing UI objects, the UI object server 224 also transmits the UI objects to the appropriate content distribution system(s). In accordance with one implementation, the UI object server 224 transmits each UI object to the appropriate content distribution system(s) 116 in accordance with directions received from the UI object scheduling module 228, as described below. The UI object server 224 transmits the UI objects to the appropriate content distribution system(s) 116 via the UI object transmission channel 136.

The program guide 226 includes guide information that specifies, for each content distribution system connected to the UI object processing system 132, the times at which various broadcast content is to be transmitted from the content distribution system 116 to the audio/video display systems 120. Stated another way, the program guide 226 includes schedules setting forth the times at which broadcast content from each content provider system 110 connected to the UI object processing system 132 is to be broadcast to audio/video display systems 120 from each of the content distribution systems 116 connected to the UI object processing system 132. As will now be described, the guide information is used by the scheduling module 228 for scheduling the transmission of UI objects.

In general, the scheduling module 228 performs a number of functions related to the timing of the distribution and use of the UI objects. In accordance with implementations, the scheduling module 228 uses UI object scheduling information together with guide information from the program guide 226 to determine various timing information, as will now be described.

In accordance with one implementation, the scheduling module 228 determines the appropriate times at which each of the UI object located at the UI object server 224 are to be transmitted to appropriate content distribution system(s). This timing information, referred to herein in as “initial distribution timing information,” is either sent to the UI object server 224 in “real time,” such that the initial distribution timing information associated with a given UI object is received by the UI object server 224 just before the given UI object is to be transmitted from the UI object server 224, or in a “batch,” where the initial distribution timing information associated with a number of UI objects is sent to the UI object server 224 in advance. This batch initial distribution timing information is then stored and used by the UI object server 224 to schedule the transmission of UI objects to the appropriate content distribution system(s).

In accordance with another implementation, the scheduling module 228 determines the appropriate times at which each UI object should be transmitted from the content distribution system(s) 116 to audio/video display systems 120. This timing information, referred to herein in as “intermediate distribution timing information,” is then either transmitted to the appropriate content distribution system(s) in real time or in a batch. The intermediate distribution timing information is then used by the content distribution system(s) 116 in timing the transmission of the UI objects to the appropriate audio/video display systems 120.

In accordance with yet another implementation, the scheduling module 228 determines the appropriate times at which each UI object should be used by a UI application on an audio/video display systems 120 to display an interactive UI. This timing information, referred to herein “display timing information,” may include not only the time at which a given UI object is to be used on an audio/video display systems 120, but also the specific channel over which the interactive UI created from the UI object should be displayed.

Once determined, this display timing information is then transmitted to the UI timing controller 516 in each appropriate content distribution system(s) 116 either in real time or in a batch. The display timing information is then used by the UI timing controller(s) 516 in the content distribution system(s) 116 to cause or trigger the rendering of interactive UIs using the appropriate UI objects in the appropriate audio/video display systems 120.

In accordance with one implementation, the display timing information is sent in a multicast, such as an IP multicast, over an out-of-band channel to a number of audio/video display systems. In accordance with this embodiment, the display timing information may specify that if an audio/video display system receiving the display timing information is currently tuned to a particular channel, a particular UI object should be accessed and used to render a particular UI.

In accordance with another implementation, the display timing information may be embedded or encoded within broadcast content. For example, the display timing information may comprise information encoded in broadcast content that specifies a particular UI object that is to be accessed and used to render a particular UI. In such a case, the embedded or encoded display timing may be embedded or encoded within the broadcast content of a given channel. This embedded or encoded content would indicate to the UI application the particular UI object that is to be accessed and used to render a particular UI over or in conjunction with the broadcast content being displayed on the given channel.

In accordance with one implementation, the UI object processing system 132 includes or is embodied in a computing system, such as described below with respect to FIG. 8. In accordance with this implementation, each of the UI authoring environment service 220, UI object validation module 222, UI object server 224, program guide 226, and scheduling module 228 comprise or include computer executable instructions stored on computer-readable media. In accordance with other implementations, the various functions described above with respect to the UI object processing system 132, the UI authoring environment service 220, the UI object validation module 222, the UI object server 224, program guide 226, and/or the scheduling module 228, may be embodied, all our part, in various other arrangements of hardware, software, and/or firmware.

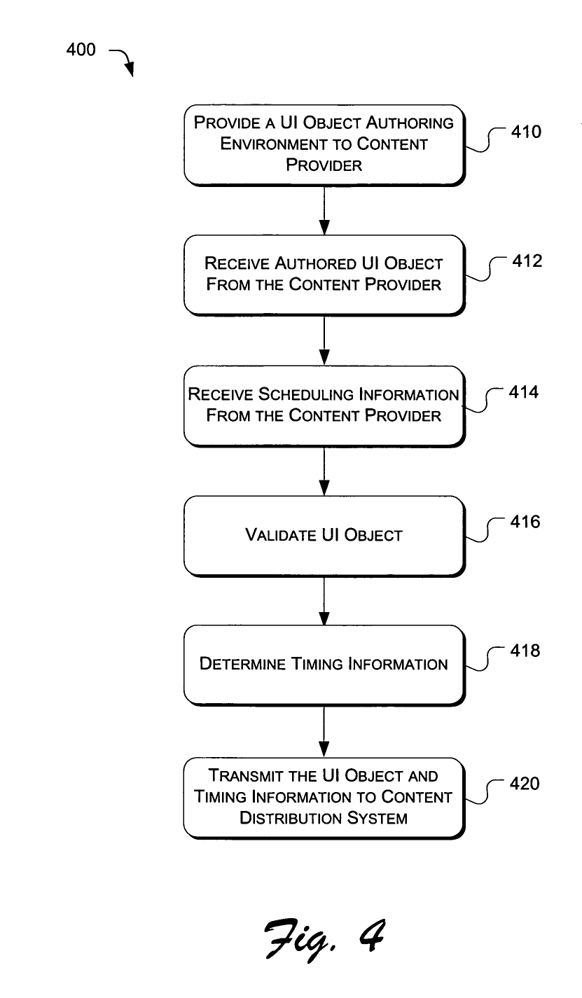

FIG. 4 illustrates an operational flow 400 or algorithm including various operations or algorithmic steps that may be performed at or by the UI object processing system 132. As shown, at the beginning of the operational flow 400, a UI object authoring environment is provided to the content provider system 110 at providing operation 410. As previously described, in accordance with one implementation, the authoring environment may be provided to the content provider system 110 via a web service.

Following the providing operation 410, a receive UI object operation 412 receives an authored UI object from the content provider system 110. Next, a receive scheduling information operation 414 receives scheduling information for the received UI object from the content provider system 110. As previously noted, the UI object and the scheduling information may be received separately or at the same time. For example, in accordance with one implementation, the scheduling information may be included in, or otherwise associated with or attached to, the UI object. As previously described, in accordance with one implementation, the UI object and the scheduling information are received from the content provider system 110 over the UI object communication channel 134.

Next, the UI object received at operation 412 is validated at validation operation 416. In accordance with one implementation, the validation operation 416 validates the UI object. In accordance with one implementation, the UI object validation operation 416 validates the UI object using a UI object rule set. That is, the UI object validation operation 416 verifies that the UI object conforms to the various rules set forth in the UI object rule set. For example, and without limitation, the UI object validation operation 416 may validate the syntax, length, format, parameters, and other attributes of the UI object.

Following the UI object validation operation 416, a timing determination operation 418 determines timing information for the UI object received at operation 412. The timing information determined by the timing determination operation 418 may be wither initial distribution timing information, intermediate timing information, and/or display timing information, as described above. In accordance with one implementation, the timing determination operation 418 determines the timing information in the manner or manners described above with respect to the UI object scheduling module 228.

Next, a UI object transmission operation 420 transmits the UI object received at operation 412 and the timing information determined at operation 418 to the content distribution system 116. In accordance with one implementation, the UI object and the timing information are transmitted to the content distribution system 116 via the UI object transmission channel 136, described above. As previously described, the UI object and the timing information may be sent to the content distribution system 116 either together or separately, depending on the form and/or format of the UI object and/or timing information.

Turning now to FIG. 5, illustrated therein further details of the content distribution system 116 and further details of an exemplary one of the audio/video display system 126. As previously noted, the content distribution system 116 provides various functionality related to the broadcasting of on-demand content, broadcast content, UI objects, and UI applications to audio/video display systems 120 operably connected thereto.

In accordance with one implementation, the content distribution system 116 transmits on-demand content, broadcast content, UI objects, and UI applications to the audio/video display systems 120 via the content distribution channel 122 described above. While only one representative audio/video display system 120 is shown connected to the content distribution system 116 in FIG. 1, it will be appreciated that the content distribution system 116 may be connected to, and simultaneously broadcast data to, any number of audio/video display systems 120.

As shown, the content distribution system 116 includes a content distribution system (CDS) on-demand content server 510, a CDS broadcast content server 512, a CDS UI object server 514 a transmitter module 518, and a carousel module 520. As also shown, the transmitter module 518 includes an in-band transmitter 526 and an out-of-band (OOB) transmitter 528.

The audio/video display system 120 includes a processor of 530, a receiver module 532, an A/V transceiver module 534, a remote control interface module 535, and a memory 536. Included in the receiver module 532 are an in-band tuner 538 and an out-of-band (OOB) tuner 540. Included in the memory 536 are a UI application 542, a future access list 544, an on-demand client 548, and an operating system 550. In accordance with one implementation, the audio/video display system 120 may comprise a cable television system set-top-box. As such, the audio/video display system 120 may include other features that are commonly included in a set-top-box.

The CDS on-demand content server 510 of the content distribution system 116 provides functionality related to the storage of on-demand content received from the content provider system(s) 110. Additionally, the on-demand content server 510 provides functionality related to the transmission of on-demand content to the audio/video display system(s) 120 operably connected thereto. In accordance with one embodiment, the CDS on-demand content server 510 includes or has access to computer-readable medium on which it stores received on-demand content.

In accordance with one implementation, the CDS on-demand content server 510 transmits on-demand content to the audio/video display system(s) 120 via the content distribution channel 122. In particular, in accordance with one implementation, the CDS on-demand content server 510 communicates with an on-demand client 548 on the client device to determine a channel over which to broadcast on-demand content. The CDS on-demand content server 510 then uses the in-band transmitter 526 to transmit on-demand content from the CDS on-demand content server 510 to the in-band tuner 538 of the client device(s) 538. Additionally, the CDS on-demand content server 510, together with the on-demand client 548, provides various content display control functions, such as play, pause, stop, fast-forward, and rewind, etc., to the client device 124.

The CDS broadcast content service 512 of the content distribution system 116 provides functionality related to the broadcast of content received from the content provider system(s) 110. Additionally, the CDS broadcast content service 512 provides functionality related to the transmission of broadcast content to the audio/video display system(s) 120 operably connected thereto.

In accordance with one implementation, the CDS broadcast content server 512 transmits broadcast content to the audio/video display system(s) 120 via the content distribution channel 122. In particular, in accordance with one implementation, the in-band transmitter 526 is used to transmit broadcast content from the CDS broadcast content server 512 to the in-band tuner of the client device 124.

The CDS UI object server 514 of the content distribution system 116 provides functionality related to the storage of UI objects received from the UI object processing system 132. Additionally, the CDS UI object server 514 provides functionality related to the transmission of UI objects to the audio/video display system(s) 120 operably connected thereto. In accordance with one embodiment, the CDS UI object server 514 includes or has access to computer-readable medium on which it stores received UI objects.

In accordance with one implementation, the CDS UI object server 514 transmits UI objects to the audio/video display system(s) 120 in accordance with display timing information received from the scheduling module 228 of the UI object processing system 132, as previously described. The CDS UI object server 514 may transmits UI objects to the audio/video display system(s) 120 either via the in-band transmitter 526 or the out-of-band transmitter 528. For example, in accordance with one implementation, the in-band transmitter 526 is used to transmit broadcast content from the CDS UI object server 514 to the in-band tuner of the client device 124. In accordance with another implementation, the out-of-band transmitter 528 is used to transmit broadcast content from the CDS UI object server 514 to the out-of-band tuner of the client device 124.

In accordance with yet another implementation, rather than sending UI objects directly to the in-band transmitter 526 or out-of-band transmitter 528 for transmission to the client device 124, the CDS UI object server 514 first transfers the UI objects to the carousel module 520. The UI objects are then sent from the carousel module to the in-band transmitter 526 or out-of-band transmitter 528 for transmission to the client device 124. The carousel module 520 sends a serial arrangement of UI objects to the transmitter module 518 in a cyclical manner. In this manner, each UI object in the carousel module 520 will be broadcast the client devices 124 at predetermined time intervals.

The UI timing controller 516 provides functionality for controlling the timing of the rendering of interactive UIs on the audio/video display system 120. In particular, as previously noted, the UI timing controller 516 receives display timing information from the scheduling module 228 of the UI object processing system 132. The display timing information is then used in accordance with one of to UI timing modes, either a “passive” UI timing mode or an “active” UI timing mode, to cause the CDS UI object server to send the appropriate UI object to the client device at the appropriate time(s).

The “passive UI timing mode,” may be used in the case where the UI application 542 is being continuously executed by the processor 530 of the client device 124. In this passive UI timing mode, the UI timing controller 516 determines the time at which each interactive UI 128 is to be rendered on the audio video display 126 of the audio/video display system 120. The UI timing controller 516 then sends this UI object scheduling information to the CDS UI object server 514 in real time or in a batch. The CDS UI object server 514 then sends the UI objects at the appropriate times to the transmitter module 518 for transmission to the client device 124. Since, in this passive mode, the UI application is continuously executing, the UI application will use the UI object to render the associated interactive UI on the video display 126 of the audio/video display system 120 at the time the UI object is received by the client device 124.

The active UI timing mode may be used in the case where, rather than being continuously executed, the UI application 542 selectively executed on the client device 124. In accordance with the active timing mode, the UI timing controller 516 determines the times at which each interactive UI 128 is to be rendered on the audio video display 126 of the audio/video display system 120. The UI timing controller 516 then may either signal the CDS UI object server 514 to send the UI objects at the appropriate times when they are to be used to render an interactive UI, or the UI timing controller 516 may signal the CDS UI object server 514 to send the appropriate UI object(s) to the carousel module for repeated transmission to the client device 124.

In addition to signaling the UI object server 514, the UI timing controller 516 also sends out an initialization signal to the UI application 542 at the determined times instructing the UI application 542 process a UI object. The UI application 542 then receives the UI object and renders the corresponding interactive UI on the video display 126 of the audio/video display system 120.

Turning now particularly to the client device 124. As shown the client device includes one or more processors 530 (e.g., microprocessors, controllers, or the like), which processes various instructions to control the operations of the client device 124 and communicate with other electronic and computing devices. Also included in the client device 124 are a receiver module 532, an A/V transceiver module 534, a remote control interface module 535, and a memory 536.

Included in the receiver module 532 are an in-band tuner 538 and an out-of-band tuner. In general, the in-band tuner 538 is operable to receive information transmitted over the content distribution channel 122 from the in-band transmitter 526 using an in-band channel. Similarly, the out-of-band tuner 540 is operable to receive information transmitted over the content distribution channel 122 from the out-of-band transmitter 528 using an out-of-band channel.

In general, the AN transceiver module 534 provides functionality related to the transmission of audio and video signals from the client device 124 to the video display 126. The remote control interface module 535 provides functionality related to the transmission and reception of control signal from to and from the remote control interface module 535.

The memory 536 may comprise or include one or more types of computer-readable media. For example, and without limitation, the memory 536 may include or be composed of various types of random access memory, read only memory, volatile memory, and/or nonvolatile memory. As shown, the memory includes a UI application 542, a future access list 544, an on-demand client 548, and an operating system 550.

The operating system 550 runs on the processor and provides basic control and management of hardware and basic system operations of the client device 124. For example, the operating system may provide functionality for receiving and processing signals received form the client device 124 and/or the remote control device 552 via the remote control interface module 535.

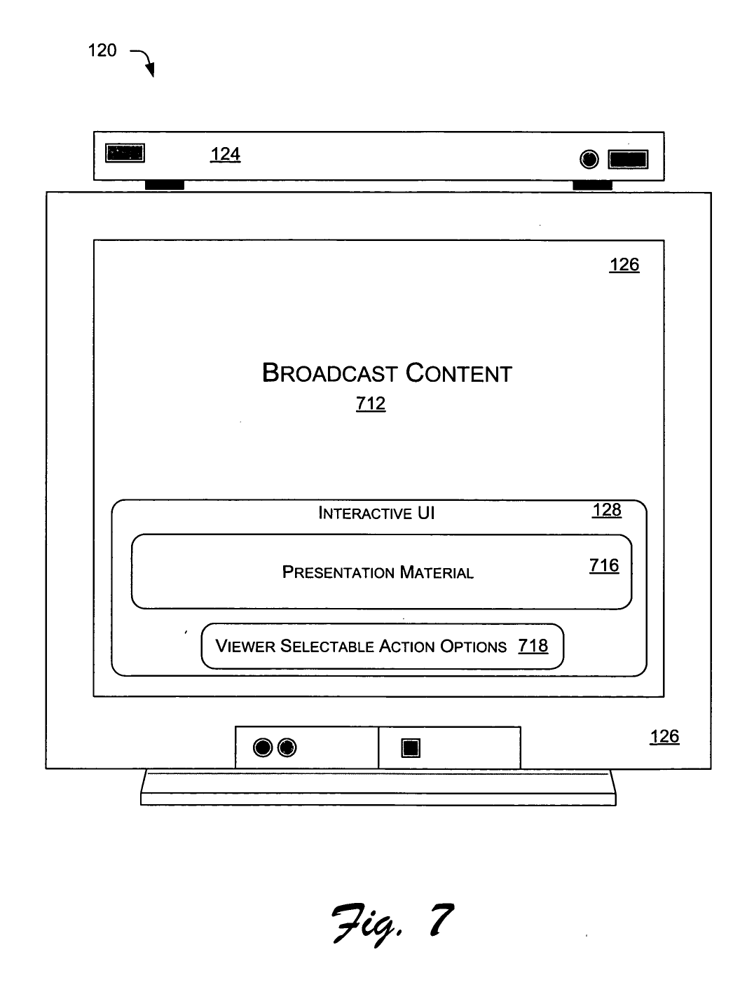

The UI application 542 comprises an application that is executable by the processor 530 and renders an interactive UI 128 on the video display 126 in accordance with data and/or logic contained in a UI object and, in some implementation, in accordance with timing information received from the UI Timing controller 516. In general, the UI application 542 includes data and executable code that is used to render a GUI on the display 126 of the audio/video display system 120. In accordance with one implementation, the UI application 542 is executed by the processor 530 in conjunction with, or under the control of, the operating system 530. As previously described, the UI application 542 renders a viewer interactive UI on the display 126 in conjunction with, or superimposed over, broadcast content. The format and function of the interactive UIs created by UI application are specified by a UI object. Further details concerning the form and function of interactive UIs rendered by the UI application 542 are described below with respect to FIG. 7.

In accordance with one implementation, the future access list module 544 is an application that is executable by the processor 530 in conjunction with, or under the control of, the operating system 530. The future access list module 544 may be operable to, among other things, render store and render on the display 126 of the audio/video display system 120, a list of the on-demand content that has been selected by a viewer of the audio/video display system 120 for future access. As described below, this list may be populated by the viewer using interactive UIs 128 presented on the display 126 of the audio/video display system 120. In accordance with one implementation, the future access list may also be operable to provide a viewer with various mechanism through which the viewer may select on-demand content for immediate viewing.

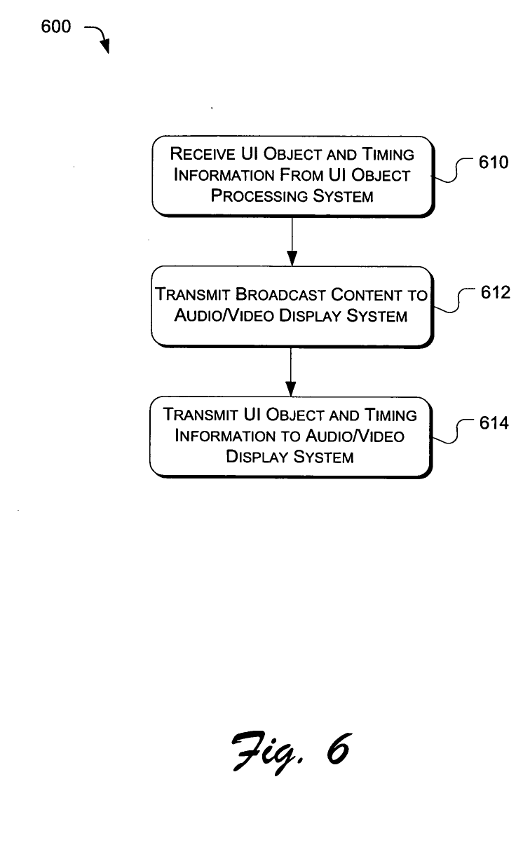

FIG. 6 illustrates an operational flow 600 or algorithm including various operations or algorithmic steps that may be performed at or by the content distribution system 116. As shown, at the beginning of the operational flow 600, a receive operation 610 receives a UI object and timing information related to the received UI object from the UI object processing system 132. The UI object and its related timing information may either be received at the same or at different times, depending whether the UI object and its related timing information were sent together or separately from the UI object processing system 132.

Next, a transmit broadcast content operation 612 transmits broadcast content to one or more audio/video display systems 120. As previously described, the broadcast content may be transmitted to the audio/video display systems 120 via various communication mechanisms. For example, and without limitation, the broadcast content may be transmitted to the audio/video display systems 120 over a content distribution channel, such as content distribution channel 122.

Next, a transmit UI object/timing information operation 614 transmits the UI object and the timing information received in receive operation 610 to one or more audio/video display systems, such as audio/video display devices 120. As previously described, the UI object and the timing information may either by transmitted to the audio/video display devices 120 together or separately, depend on the form and/or function of the UI object and the timing information. In accordance with one implementation, the UI object is transmitted to the audio/video display devices 120 as described above with respect to the CDS object server 514. Similarly, in accordance with one implementation, the timing information is transmitted to the audio/video display devices 120 as described above with respect to the UI timing controller 516.

Turning now to FIG. 7, illustrated therein is an exemplary interactive UI 128 that may be rendered by the UI application 542 on the video display 126 of the audio/video display systems 120. In accordance with one implementation, the interactive UI 128 includes various graphical elements that are superimposed over broadcast content 712 displayed on the video display 126. All or any portion of the interactive UI 128 may be solid, such that the broadcast content 712 cannot be viewed there through, or transparent, such that all or a portion of the broadcast content 712 may be viewed there through. In accordance with one implementation, the interactive UI 128 is composed of or includes one or more GUI windows.

In accordance with one implementation, the exemplary interactive UI 128 includes presentation material 716 and viewer selectable material 718. The presentation material 716 may include various graphical elements such as, without limitation, text, drawings, photographs, graphical designs, etc. The viewer selectable material 718 may include various graphical action items that may be navigated through and/or selected by a viewer of the audio/video display systems 120, such as by using the controls on the remote control device 552.

In accordance with various implementations, the various graphical elements of presentation material 716 of the various graphical action items of the viewer selectable material 718 are displayed in separate and distinct areas of the interactive UI 128, such as is shown in FIG. 7. In accordance with other implementations, the various graphical elements of presentation material 716 of the various graphical action items of the viewer selectable material 718 may be visually intermixed in the interactive UI 128, such as is shown in FIG. 7. Furthermore, the various graphical elements of presentation material 716 of the various graphical action items of the viewer selectable material 718 may be visually overlapping on another.

In accordance with one implementation, the presentation material 716 includes text and/or other graphical items that specifically promote the on-demand content over which the interactive UI 128 is rendered. In accordance with one implementation, the selectable material 718 action items may specifically related to or associated with the on-demand content over which the interactive UI 128 is rendered.

For example, in accordance with one implementation, an interactive UI 128 includes presentation material 716 that includes text and/or other graphical items that promote a Video-On-Demand movie that is available from the content provider that distributed the broadcast content over which the interactive UI 128 is displayed. Additionally, the interactive UI 128 includes viewer selectable material 718 displaying various action that the viewer may perform with respect to the promoted Video-On-Demand movie. For example, the viewer selectable material 718 may provide the viewer the options of selecting the Video-On-Demand movie for immediate viewing, selecting the Video-On-Demand movie for future viewing, or exiting the interactive UI 128.

In operation, after selecting options presented by the viewer selectable material, such as with the remote control, the UI application 542 that presented the interactive UI 128 will perform the selected option. For example, in the case where the viewer selects the Video-On-Demand movie for immediate viewing, the UI application 542 may initiate communication between the on-demand client 548 and the CDS broadcast content server 512, to cause the in-band tuner 538 to tune to the channel carrying the Video-On-Demand movie. In the case where the viewer selects the Video-On-Demand movie for future viewing, the UI application 542 may send information related to the Video-On-Demand movie to the future list module 544 for future access by viewer.

FIG. 8 illustrates one exemplary computing environment 810 in which the various systems and methods described herein may be implemented. The exemplary computing environment 810 is only one example of a suitable computing environment and is not intended to suggest any limitation as to the scope of use or functionality of the systems, methods, and data structures described herein. Neither should computing environment 810 be interpreted as having any dependency or requirement relating to any one or combination of components illustrated in computing environment 810.

The systems and methods described herein are operational with numerous other general purpose or special purpose computing system environments or configurations. Examples of well known computing systems, environments, and/or configurations that may be suitable include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The exemplary operating environment 810 of FIG. 8 includes a general purpose computing device in the form of a computer 820, including a processing unit 821, a system memory 822, and a system bus 823 that operatively couples various system components include the system memory to the processing unit 821. There may be only one or there may be more than one processing unit 821, such that the processor of computer 820 comprises a single central-processing unit (CPU), or a plurality of processing units, commonly referred to as a parallel processing environment. The computer 820 may be a conventional computer, a distributed computer, or any other type of computer.

The system bus 823 may be any of several types of bus structures including a memory bus or memory controller, a peripheral bus, and a local bus using any of a variety of bus architectures. The system memory may also be referred to as simply the memory, and includes read only memory (ROM) 824 and random access memory (RAM) 825. A basic input/output system (BIOS) 826, containing the basic routines that help to transfer information between elements within the computer 820, such as during start-up, is stored in ROM 824. The computer 820 may further includes a hard disk drive interface 827 for reading from and writing to a hard disk, not shown, a magnetic disk drive 828 for reading from or writing to a removable magnetic disk 829, and an optical disk drive 830 for reading from or writing to a removable optical disk 831 such as a CD ROM or other optical media.

The hard disk drive 827, magnetic disk drive 828, and optical disk drive 830 are connected to the system bus 823 by a hard disk drive interface 832, a magnetic disk drive interface 833, and an optical disk drive interface 834, respectively. The drives and their associated computer-readable media provide nonvolatile storage of computer-readable instructions, data structures, program modules and other data for the computer 820. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 829, optical disk 831, ROM 824, or RAM 825, including an operating system 835, one or more application programs 836, other program modules 837, and program data 838. A user may enter commands and information into the personal computer 820 through input devices such as a keyboard 840 and pointing device 842. Other input devices (not shown) may include a microphone, joystick, game pad, satellite dish, scanner, or the like. These and other input devices are often connected to the processing unit 821 through a serial port interface 846 that is coupled to the system bus, but may be connected by other interfaces, such as a parallel port, game port, or a universal serial bus (USB). A monitor 847 or other type of display device is also connected to the system bus 823 via an interface, such as a video adapter 848. In addition to the monitor, computers typically include other peripheral output devices (not shown), such as speakers and printers.

The computer 820 may operate in a networked environment using logical connections to one or more remote computers, such as remote computer 849. These logical connections may be achieved by a communication device coupled to or a part of the computer 820, or in other manners. The remote computer 849 may be another computer, a server, a router, a network PC, a client, a peer device or other common network node, and typically includes many or all of the elements described above relative to the computer 820, although only a memory storage device 850 has been illustrated in FIG. 8. The logical connections depicted in FIG. 8 include a local-area network (LAN) 851 and a wide-area network (WAN) 852. Such networking environments are commonplace in office networks, enterprise-wide computer networks, intranets and the Internal, which are all types of networks.

When used in a LAN-networking environment, the computer 820 is connected to the local network 851 through a network interface or adapter 853, which is one type of communications device. When used in a WAN-networking environment, the computer 820 typically includes a modem 854, a type of communications device, or any other type of communications device for establishing communications over the wide area network 852. The modem 854, which may be internal or external, is connected to the system bus 823 via the serial port interface 846. In a networked environment, program modules depicted relative to the personal computer 820, or portions thereof, may be stored in the remote memory storage device. It is appreciated that the network connections shown are exemplary and other means of and communications devices for establishing a communications link between the computers may be used.

Although some exemplary systems and methods have been illustrated in the accompanying drawings and described in the foregoing Detailed Description, it will be understood that the systems and methods shown and described are not limited to the exemplary embodiments and implementations described, but are capable of numerous rearrangements, modifications and substitutions without departing from the spirit set forth and defined by the following claims.

1. A system comprising:
a content server configured to transmit broadcast content to a set-top-box for presentation on a video display device operably connected to the set-top-box; and
a user interface (UI) object server configured to transmit a UI object to the set-top-box, the UI object comprising instructions for causing the set-top-box to render a UI on the video display device simultaneously with the presentation of the broadcast content, the rendered UI including information related to on-demand content.

2. A system as recited in claim 1, wherein the content server and the UI object server are contained in a single headend device.

3. A system as recited in claim 1, further comprising a UI timing controller configured to control the timing of the rendering of the UI on the video display device.

4. A system as recited in claim 1, further comprising a UI timing controller operably connected to a UI application in the set-top-box, the UI timing controller being configured to cause the UI application to render the UI on the video device.

5. A system as recited in claim 1, further comprising a data carousel configured to transmit the UI object to the set-top-box.

6. A system as recited in claim 1, further comprising an in-band transmitter configured to transmit the content to the set-top-box and an out-of-band transmitter configured to transmit the UI object to the set-top-box.

7. A system as recited in claim 1, wherein the content is transmitted from the content server to the set-top-box by an out-of-band transmitter and the UI object is transmitted from the UI object server to the set-top-box by an out-of-band transmitter.

8. A system as recited in claim 1, wherein the content server comprises a broadcast content server configured to transmit broadcast content to the set-top-box and wherein the system further comprises an on-demand content server configured to transmit on-demand content to the set-top-box.

9. A system as recited in claim 1, wherein the rendered UI includes information advertising the on-demand content.

10. A system as recited in claim 1, wherein the UI object comprises instructions for causing the set-top-box to render a UI on the video device that presents viewer selectable options for accessing the on-demand content.

11. A system as recited in claim 1, wherein the rendered UI includes viewer selectable options for one of immediately accessing the on-demand content and accessing the on-demand content at a later time.

12. A system as recited in claim 1, wherein the rendered UI includes viewer selectable options for one of immediately accessing the on-demand content and placing a reference to the on-demand content in a future access list.

13. A system as recited in claim 1, wherein:
the content server comprises a broadcast content server configured to transmit the broadcast content to the set-top-box;
the system further comprises an on-demand content server configured to transmit the on-demand content to the set-top-box; and
the UI object comprises instructions for causing the set-top-box to render a UI on the video device that presents viewer selectable options for accessing the on-demand content.

14. A system as recited in claim 1, wherein:
the content server comprises a broadcast content server configured to transmit the broadcast content to the set-top-box;
the system further comprises an on-demand content server configured to transmit the on-demand content to the set-top-box; and
the UI object comprises instructions for causing the set-top-box to render a UI on the video device that presents viewer selectable options for one of immediately accessing the on-demand content and accessing the on-demand content at a later time.

15. A system as recited in claim 1, wherein:
the content server comprises a broadcast content server configured to transmit the broadcast content to the set-top-box;
the system further comprises an on-demand content server configured to transmit the on-demand content to the set-top-box;
the system further comprises an in-band transmitter configured to transmit the on-demand content and the broadcast content to the set-top-box; and
the system further comprises an out-of-band transmitter configured to transmit UI objects to the set-top-box.

16. A system comprising:
a user interface (UI) authoring environment service configured to present a UI authoring environment for creating a UI object, the UI object comprising instructions for causing a set-top-box to render a UI on a video display device operably connected to the set-top-box;
a programming guide including information indicating at least one time at which content is scheduled for transmission from a headend device to the set-top-box; and
a UI object scheduling module configured to produce scheduling information associated with the UI object.

17. A system as recited in claim 16, wherein the timing information indicates a time at which the UI object is to be sent from the system to the headend device.

18. A system as recited in claim 16, wherein the timing information indicates multiple times at which the UI object is to be sent from the headend device to the set-top-box.

19. A system as recited in claim 16, wherein the timing information indicates a time at which the at least one UI object is to be used to render the UI on the video display device.

20. A system as recited in claim 16, wherein the at least one UI object comprises instructions for causing the set-top-box to render a UI on the video display device that presents viewer selectable options for accessing on-demand content.

21. A system as recited in claim 16, wherein the UI authoring environment service comprises a web service.

22. A system as recited in claim 16, further comprising:
a UI object validation module configured to determine the validity of the UI object.

23. A system as recited in claim 16, further comprising:
a UI object validation module configured to determine the validity of the UI object based on a UI object rule set.

24. A system as recited in claim 16, further comprising:
a UI object server configured to store the UI object.

25. A system comprising:
a processor; and
a user interface (UI) application executed on the processor, the UI application configured to render a UI including information related to on-demand content over broadcast content displayed on a video display device operably connected to the system, the UI application rendering the UI based on information contained in a UI object.

26. A system as recited in claim 25, wherein the rendered UI includes information advertising the on-demand content.

27. A system as recited in claim 25, wherein the rendered UI presents viewer selectable options for accessing the on-demand content.

28. A system as recited in claim 25, wherein the rendered UI presents viewer selectable options for one of immediately accessing the on-demand content and accessing the on-demand content at a later time.

29. A system as recited in claim 25, wherein the rendered UI presents viewer selectable options for one of immediately accessing the on-demand content and placing a reference to the on-demand content in a future access list.

30. A system as recited in claim 25, further comprising a future access list, and wherein the rendered UI presents viewer selectable options for placing a reference to the on-demand content in the future access list.

31. A system as recited in claim 25, wherein the UI application is configured to receive timing signals indicating a time at which the UI application is to render the UI.

32. A system as recited in claim 25, wherein the UI application is configured to receive timing signals encoded in the broadcast content, the timing signals indicating a time at which the UI application is to render the UI.

33. A system as recited in claim 25, wherein the UI application is configured to receive timing signals from a headend device and to render the UI at a time indicated by the timing signals.

34. A method comprising:
transmitting broadcast content to a set-top-box for presentation on a video display device operably connected to the set-top-box; and
transmitting a UI object to the set-top-box, the UI object comprising instructions that cause the set-top-box to render a UI including information related to on-demand content on the video device simultaneously with the presentation of the broadcast content.

35. A method as recited in claim 34, further comprising:
transmitting a timing signal to the set-top-box for use in determining a time at which the UI is rendered on the video device.

36. A method as recited in claim 34, wherein the act of transmitting the UI object to the set-top-box further comprises transmitting the UI object to the set-top-box using a data carousel.

37. A method as recited in claim 34, wherein the act of transmitting the UI object to the set-top-box further comprises transmitting the UI object to the set-top-box using an out-of-band transmitter.

38. A method as recited in claim 34, wherein the act of transmitting the UI object to the set-top-box further comprises transmitting the UI object to the set-top-box using an out-of-band transmitter and the act of transmitting broadcast content to a set-top-box comprises transmitting the content to the set-top-box using an in-band transmitter.

39. A method as recited in claim 34, wherein the rendered UI includes information advertising the on-demand content.

40. A method as recited in claim 34, wherein the rendered UI includes viewer selectable options for accessing the on-demand content.

41. A method as recited in claim 34, wherein the rendered UI includes viewer selectable options for one of immediately accessing the on-demand content and accessing the on-demand content at a later time.

42. A method as recited in claim 34, wherein the rendered UI object includes viewer selectable options for one of immediately accessing the on-demand content and placing a reference to the on-demand content in a future access list.

43. One or more computer-readable media containing computer executable instructions that, when executed by a computer, perform acts of:
transmitting broadcast content to a set-top-box for presentation on a video display device operably connected to the set-top-box; and
transmitting a UI object to the set-top-box, the UI object comprising instructions that cause the set-top-box to render a UI on the video device simultaneously with the presentation of the broadcast content, the UI displaying information related to on-demand content.

44. One or more computer-readable media as recited in claim 43, further containing computer executable instructions that, when executed by the computer, further perform an act of:
transmitting a timing signal to the set-top-box for use in determining a time at which the UI is rendered on the video device.

45. One or more computer-readable media as recited in claim 43, wherein the act of transmitting the UI object to the set-top-box further comprises transmitting the UI object to the set-top-box using a data carousel.

46. One or more computer-readable media as recited in claim 43, wherein the act of transmitting the UI object to the set-top-box further comprises transmitting the UI object to the set-top-box using an out-of-band transmitter.

47. One or more computer-readable media as recited in claim 43, wherein the act of transmitting the UI object to the set-top-box further comprises transmitting the UI object to the set-top-box using an out-of-band transmitter and the act of transmitting broadcast content to a set-top-box comprises transmitting the content to the set-top-box using an in-band transmitter.

48. One or more computer-readable media as recited in claim 43, wherein the rendered UI includes information advertising the on-demand content.

49. One or more computer-readable media as recited in claim 43, wherein the rendered UI includes viewer selectable options for accessing the on-demand content.

50. One or more computer-readable media as recited in claim 43, wherein the rendered UI includes viewer selectable options for one of immediately accessing the on-demand content and accessing the on-demand content at a later time.

51. One or more computer-readable media as recited in claim 43, and wherein the rendered UI object includes viewer selectable options for one of immediately accessing the on-demand content and placing a reference to the on-demand content in a future access list.

52. On or more computer-readable media containing computer executable instructions that, when executed by a computer, perform acts of:
using information contained in a user interface (UI) object to render a graphical user interface (GUI) on a video display device in conjunction with broadcast content displayed on the video display device, the GUI displaying information related to on-demand content.

53. One or more computer-readable media as recited in claim 52, wherein the rendered GUI includes information related to on-demand content that is immediately accessible to the system.

54. One or more computer-readable media as recited in claim 52, wherein the rendered GUI presents viewer selectable options for accessing the on-demand content.

55. One or more computer-readable media as recited in claim 52, wherein the GUI is superimposed on the displayed broadcast content.

56. One or more computer-readable media as recited in claim 52, wherein the rendered GUI presents viewer selectable options for one of immediately accessing the on-demand content and accessing the on-demand content at a later time.

57. One or more computer-readable media as recited in claim 52, wherein the rendered GUI presents viewer selectable options for one of immediately accessing the on-demand content and placing a reference to the on-demand content in a future access list.

58. One or more computer-readable media as recited in claim 52, wherein the GUI is rendered on the on a video display device in accordance with timing instructions.

59. A method comprising:
transmitting broadcast content to a content distribution system for distribution to a plurality of audio/video display systems; and
transmitting a user interface (UI) object and scheduling information to a UI object processing system, the UI object including directions for rendering a UI including information related to on-demand content on an audio/video display system, the scheduling information including information for determining a time at which the UI is to be displayed on the audio/video display system over broadcast content.

60. A method as recited in claim 59, further comprising:
authoring the UI object using an authoring environment provided by the UI object processing system.

61. A method as recited in claim 59, further comprising:
authoring the UI object using an authoring environment web service provided by the UI object processing system.

62. A method as recited in claim 59, wherein the UI object includes directions for displaying a graphical user interface on the audio/video display systems.

63. A method as recited in claim 59, wherein the UI object comprises a binary resource file.

64. A method comprising:
receiving a user interface (UI) object and scheduling information, the UI object including directions for rendering a UI including information related to on-demand content on an audio/video display system; and
using the scheduling information to produce timing information, the timing information indicating a time at which the UI is to be displayed on the audio/video display system over broadcast content.

65. A method as recited in claim 64, further comprising transmitting the UI object and the timing information to a content distribution system.

66. A method as recited in claim 64, further comprising transmitting the UI object and the timing information to a cable television head-end.

67. A method as recited in claim 64, wherein the act of using the scheduling information to produce timing information further comprises accessing a program guide to determine the timing information.

68. A method as recited in claim 64, wherein the timing information includes information indicating a time at which the UI object is to be transmitted from content distribution system to the audio/video display system.

69. A method as recited in claim 64, wherein the timing information includes information indicating a time at which the UI object is to be transmitted from content distribution system to the audio/video display system.
